(19) United States
(12) Patent Application Publication
(10) Pub. No.: US 2011/0166940 A1
(43) Pub. Date: Jul. 7, 2011

(54) Micro-impulse radar detection of a human demographic and delivery of targeted media content

(75) Inventors: Mahalaxmi Gita Bangera, Renton, WA (US); Roderick A. Hyde, Redmond, WA (US); Muriel Y. Ishikawa, Livermore, CA (US); Edward K.Y. Jung, Bellevue, WA (US); Jordin T. Kare, Seattle, WA (US); Eric C. Leuthardt, St. Louis, MO (US); Nathan P. Myhrvold, Bellevue, WA (US); Elizabeth A. Sweeney, Seattle, WA (US); Clarence T. Tegreene, Bellevue, WA (US); David B. Tuckerman, Lafayette, CA (US); Lowell L. Wood, JR., Bellevue, WA (US); Victoria Y.H. Wood, Livermore, CA (US)

(73) Assignee: Searete LLC, Bellevue, WA (US)

(21) Appl. No.: 12/655,808

(22) Filed: Jan. 5, 2010

(51) Int. Cl. G06Q 30/00; H04N 7/025; G01S 13/04; G06F 17/00

(52) U.S. Cl. 705/14.66; 725/34; 342/27; 700/94

(57) ABSTRACT

A micro-impulse radar (MIR) may be configured to provide information about at least one person in a region. A media output device may be driven responsive to the information to output media content to the at least one person.

### SUMMARY

According to an embodiment, a system for delivering media content to one or more target demographics may include a signal output configured to operatively couple to an output device, a media source configured to provide media content targeted at one or more human demographics, a micro-impulse radar (MIR), the MIR being configured to detect persons in a region, and an electronic controller operatively coupled to the signal output, the media source, and the MIR. The electronic controller may be configured to determine if data received from the MIR corresponds to one or more persons meeting the one or more demographics, and if a person in the region meets at least one demographic, drive the signal output to output the at least one media content targeted at the demographic.

According to an embodiment, a method for delivering media content to at least one person having a target demographic includes probing a region with a MIR, receiving scattered MIR radiation from the region with a receiver, generating MIR data from the received scattered MIR radiation, and determining from the MIR data a probability of the region including one or more persons corresponding to a target demographic. Media content may be output to the region if the probability is equal to or greater than a predetermined value.

According to an embodiment, a method for providing selected information to one or more persons includes receiving, from a MIR, information corresponding to one or more characteristics of one or more persons in a region and outputting media to the region responsive to the one or more characteristics.

According to an embodiment, a media output system may be configured to output content responsive to at least one human demographic. The media output system may include a media device configured to output media content to a viewing region; a MIR configured to probe an examination region coincident with or different than the viewing region, and generate an output signal; and a controller configured to receive the MIR output signal, determine one or more human demographics entering or in the viewing region, and responsively select media content for output through the media output device.

According to an embodiment, a control module for an adaptive media delivery system includes a media source, a display drive port configured to drive one or more media displays, a media delivery controller operatively coupled to the media source and the display drive port, and a MIR or a MIR port configured to provide data related to at least one viewer to the media delivery controller.

According to an embodiment, a tangible computer readable medium may carry computer-executable instructions to cause a computer to receive MIR data, determine at least one human demographic from the MIR data, and select for output media content as a function of the human demographic.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a simplified block diagram of a micro-impulse radar (MIR), according to an embodiment.

FIG. 2 is a flow chart showing an illustrative process for determining the presence of a person in a region with the MIR of FIG. 1, according to an embodiment.

FIG. 3 is a flow chart showing an illustrative process for determining a physiological parameter of a person in a region with the MIR of FIG. 1, according to an embodiment.

FIG. 4 is a flow chart showing an illustrative process for determining a demographic of a person in region with the MIR of FIG. 1, according to an embodiment.

FIG. 5 is a block diagram of a system for delivering media content to a target demographic, according to an embodiment.

FIG. 6 is a flow chart illustrating a method for delivering media content to at least one person having a target demographic, according to an embodiment.

FIG. 7 is a simplified flow chart showing a method for providing selected information to one or more persons, according to an embodiment.

FIG. 8 illustrates an arrangement for providing media targeted to persons in a region that may include a public space, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

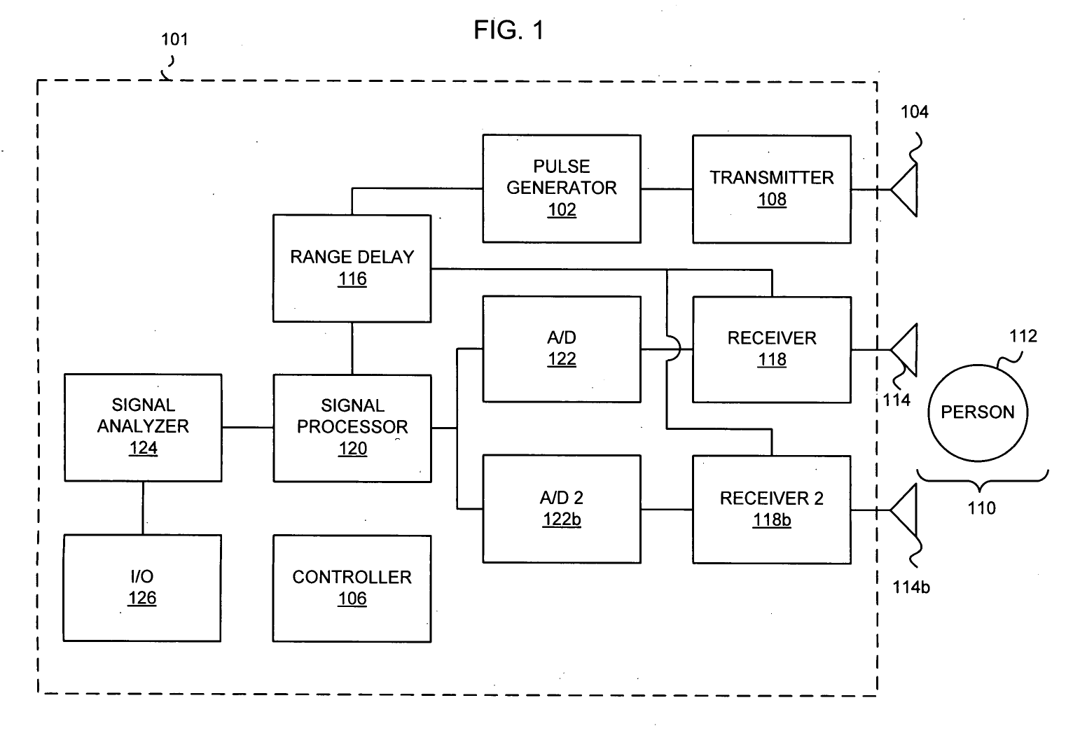

FIG. 1 is a simplified block diagram of a micro-impulse radar (MIR) 101, according to an embodiment. A pulse generator 102 is configured to output a relatively short voltage pulse that is applied to a transmit antenna 104. A typical transmitted pulse width may be between about two hundred picoseconds and about 5 nanoseconds, for example. The voltage pulse may be conditioned and amplified (or attenuated) for output by a transmitter 108. For example, the transmitter 108 may transmit the voltage pulse or may further condition the pulse, such as by differentiating a leading and/or trailing edge to produce a short sub-nanosecond transmitted pulses. The voltage pulse is typically not modulated onto a carrier frequency. Rather, the voltage pulse transmission spectrum is the frequency domain transform of the emitted pulse. The MIR 101 may probe a region 110 by emitting a series of spaced voltage pulses. For example, the series of voltage pulses may be spaced between about 100 nanoseconds and 100 microseconds apart. Typically, the pulse generator 102 emits the voltage pulses with non-uniform spacing such as random or pseudo-random spacing, although constant spacing may be used if interference or compliance is not a concern. Spacing between the series of voltage pulses may be varied responsive to detection of one or more persons 112 in the region 110. For example, the spacing between pulses may be relatively large when a person 112 is not detected in the region 112. Spacing between pulses may be decreased (responsive to one or more commands from a controller 106) when a person 112 is detected in the region 110. For example, the decreased time between pulses may result in faster MIR data generation for purposes of more quickly determining information about one or more persons 112 in the region 110. The emitted series of voltage pulses may be characterized by spectral components having high penetration that may pass through a range of materials and geometries in the region 110.

An object 112 (such as a person) in the probed region 110 may selectively reflect, refract, absorb, and/or otherwise scatter the emitted pulses. A return signal including a reflected, refracted, absorbed, and/or otherwise scattered signal may be received by a receive antenna 114. Optionally, the receive antenna 114 and transmit antenna 104 may be combined into a single antenna. In a single antenna embodiment, a filter (not shown) may be used to separate the return signal from the emitted pulse.

A probed region 110 may be defined according to an angular extent and distance from the transmit antenna 104 and the receive antenna 114. Distance may be determined by a range delay 116 configured to trigger a receiver 118 operatively coupled to the receive antenna 114. For example, the receiver 118 may include a voltage detector such as a capture-and-hold capacitor or network. The range delay corresponds to distance into the region 110. Range delay may be modulated to capture information corresponding to different distances.

A signal processor 120 may be configured to receive detection signals or data from the receiver 118 and the analog to digital converter 122, and by correlating range delay to the detection signal, extract data corresponding to the probed region 110 including the object 112.

Optionally, the MIR 101 may include a second receive antenna 114b. The second receive antenna may be operatively coupled to a second receiver 118b coupled to an output of the range delay 116 or a separate range delay (not shown) configured to provide a delay selected for a depth into the region 110. The signal processor 120 may further receive output from a second A/D converter 122b operatively coupled to the second receiver 118b.

The signal processor 120 may be configured to compare detection signals received by the antennas 114, 114b. For example, the signal processor 120 may search for common signal characteristics such as similar reflected static signal strength or spectrum, similar (or corresponding) Doppler shift, and/or common periodic motion components, and compare the respective range delays corresponding to detection by the respective antennas 114, 114b. Signals sharing one or more characteristics may be correlated to triangulate to a location of one or more objects 112 in the region 110 relative to known locations of the antennas 114, 114b. The triangulated locations may be output as computed ranges of angle or computed ranges of extent.

For example, a first signal corresponding to a reflected pulse received by an antenna element 114 may be digitized by an analog-to-digital converter (A/D) 122 to form a first digitized waveform. A second signal corresponding to the reflected pulse received by a second antenna element 114b may similarly be digitized by and A/D 122b (or alternatively by the same A/D converter 122) to form a second digitized waveform. The signal processor 120 may compare the first and second digitized waveforms and deduce angular information from the first and second digitized waveforms and known geometry of the first and second antenna elements.

A second pulse may be received at a second range delay 116 value and may be similarly signal processed to produce a second set of angular information that maps a second surface at a different distance. Depth within a given range delay may be inferred from a strength of the reflected signal. A greater number of signals may be combined to provide additional depth information. A series of pulses may be combined to form a time series of signals corresponding to the object 112 that includes movement information of the object 112 through the region 110. The object 112 described herein may include one or more persons.

The signal processor 120 outputs MIR data. The MIR data may include object location information, object shape information, object velocity information, information about inclusion of high density and/or conductive objects such as jewelry, cell phones, glasses including metal, etc., and physiological information related to periodic motion. The MIR data may include spatial information, time-domain motion information, and/or frequency domain information. Optionally, the MIR data may be output in the form of an image. MIR data in the form of an image may include a surface slice made of pixels or a volume made of voxels. Optionally, the image may include vector information.

The MIR data from the signal processor 120 is output to a signal analyzer 124. The signal analyzer 124 may be integrated with the signal processor 120 and/or may be included in the same MIR 101, as shown. Alternatively, the signal processor 120 may output MIR data through an interface to a signal analyzer 124 included in an apparatus separate from the MIR 101.

A signal analyzer 124 may be configured to extract desired information from MIR data received from the signal processor 120. Data corresponding to the extracted information may be saved in a memory for access by a data interface 126 or may be pushed out the data interface 126.

The signal analyzer 124 may be configured to determine the presence of a person 112 in the region 110. For example, MIR data from the signal processor may include data having a static spectrum at a location in the region 110, and a periodic motion spectrum corresponding to the location characteristic of a human physiological process (e.g. heartbeat and/or breathing). From the correspondence of such MIR data, it may be deduced that a person 112 is at the location in the region 110. The signal analyzer 124 may be configured to determine a number of persons 112 in the region 110. The signal analyzer 124 may be configured to determine the size of a person and/or relative size of anatomical features of a person 112 in the region 110. The signal analyzer 124 may be configured to determine the presence of an animal 112 in the region 110. The signal analyzer 124 may be configured to determine movement and/or speed of movement of a person 112 through the region 110. The signal analyzer 124 may be configured to determine or infer the orientation of a person 112 such as the direction a person is facing relative to the region 110. The signal analyzer 124 may be configured to determine one or more physiological aspects of a person 112 in the region 110. The signal analyzer 124 may determine presence of a personal appliance such as a cell phone, PDA, etc. and/or presence of metallized objects such as credit cards, smart cards, access cards, etc. The signal analyzer 124 may infer the gender and age of one or more persons based on returned MIR data. For example, male bodies may generally be characterized by higher mass density than female bodies, and thus may be characterized by somewhat greater reflectivity at a given range. Adult female bodies may exhibit relatively greater harmonic motion (“jiggle”) responsive to movements, and may thus be correlated to harmonic spectra characteristics. Older persons generally move differently than younger persons, allowing an age inference based on detected movement in the region 110.

By determination of one or more such aspects and/or combinations of aspects, the signal analyzer 124 may determine a demographic of one or more persons 112 in the region 110.

For example, MIR data may include movement corresponding to the beating heart of one or more persons 112 in the region 110. The signal analyzer 124 may filter the MIR data to remove information not corresponding to a range of heart rates, and determine one or more heart rates by comparing movement of the heart surface to the MIR signal rate. The one or more heart rates may further be characterized according to a confidence factor, depending on statistical certainty regarding the determined one or more heart rates.

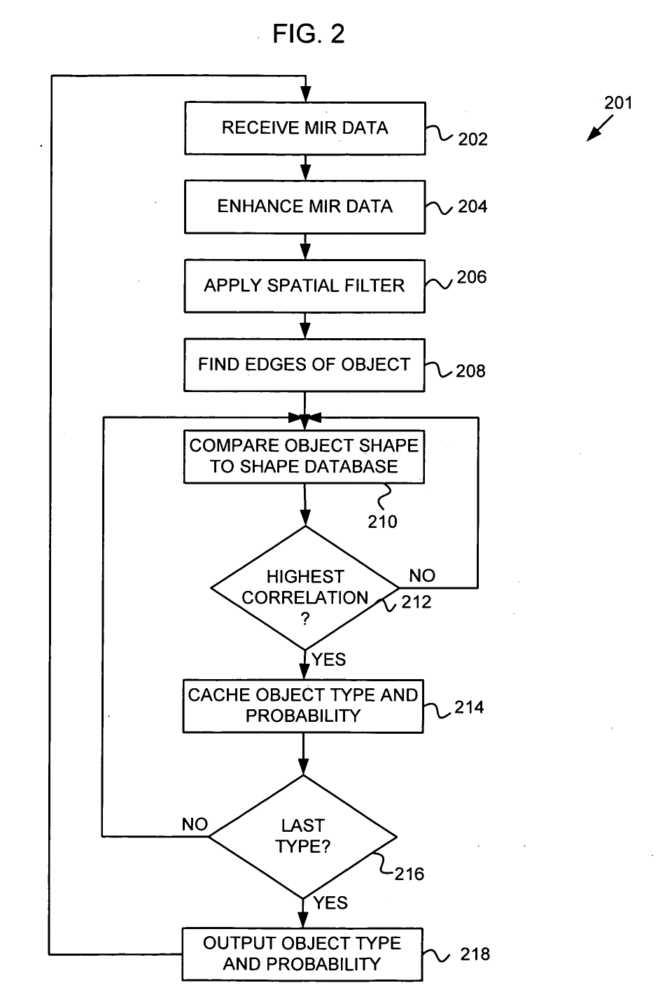

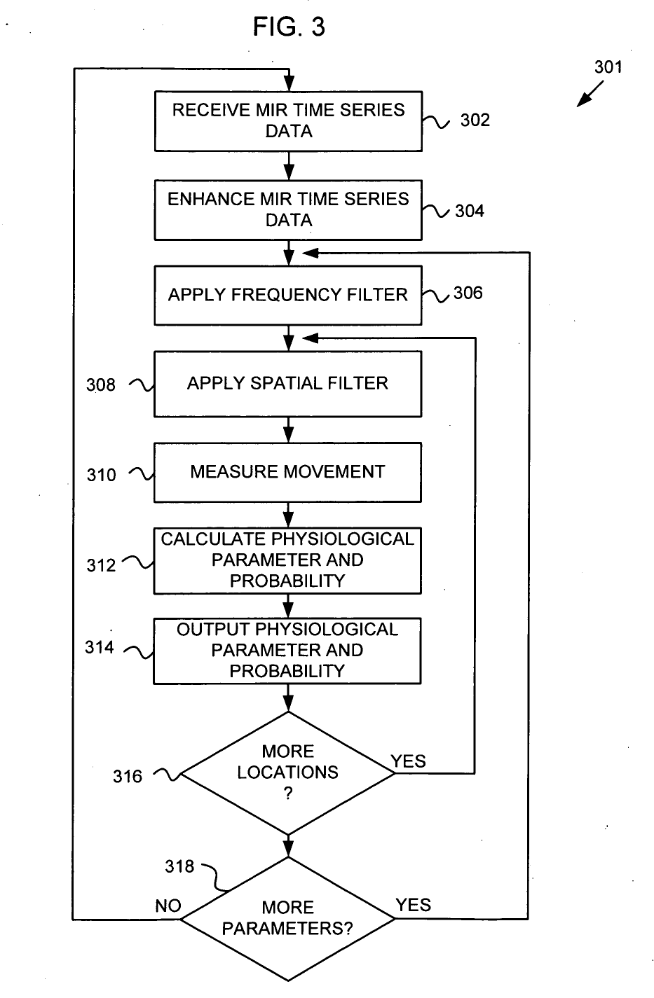

Similarly, the signal analyzer 124 may determine one or more respiration rates by measuring movement corresponding to the chest or diaphragm of one or more persons 112. The signal analyzer 124 may determine movement, a direction of movement, and/or a rate of movement of one or more persons 112 in the region 110. Operation of the signal analyzer 124 is described in greater detail below by reference to FIGS. 2 and 3.

An electronic controller 106 may be operatively coupled to the pulse generator 102, the transmitter 108, the range delay 116, the receiver 118, the analog-to-digital converter 122, the signal processor 120, and/or the signal analyzer 124 to control the operation of the components of the MIR 101. For embodiments so equipped, the electronic controller 106 may also be operatively coupled to the second receiver 118b, and the second analog-to-digital converter 122b. The data interface 126 may include a high speed interface configured to output of data from the signal analyzer 124. Alternatively, for cases where signals are analyzed externally to the MIR, the data interface 126 may include a high speed interface configured to output MIR data from the signal processor 120. The data interface 126 may include an interface to the controller 106. Optionally, the controller 106 may be interfaced to external systems via a separate interface (not shown).

FIG. 2 is a flow chart showing an illustrative process 201 for determining the presence of one or more persons 112 in the region 110 with the signal analyzer 124 of the MIR 101, according to an embodiment. Beginning with step 202, MIR data is received as described above in conjunction with FIG. 1. The MIR data may correspond to a plurality of probes of the region 110. Proceeding to optional step 204, the MIR data may be enhanced to facilitate processing. For example, grayscale data corresponding to static reflection strength as a function of triangulated position may be adjusted, compressed, quantized, and/or expanded to meet a desired average signal brightness and range. Additionally or alternatively, velocity information corresponding to Doppler shift, and/or frequency transform information corresponding to periodically varying velocity may similarly be adjusted, compressed, quantized, and/or expanded. Systematic, large scale variations in brightness may be balanced, such as to account for side-to-side variations in antenna coupling to the region. Contrast may be enhanced such as to amplify reflectance variations in the region.

Proceeding to optional step 206, a spatial filter may be applied. Application of a spatial filter may reduce processing time and/or capacity requirements for subsequent steps described below. The spatial filter may, for example, include a computed angle or computed extent filter configured to remove information corresponding to areas of contrast, velocity, or frequency component(s) having insufficient physical extent to be large enough to be an object of interest. The spatial filter may, for example, identify portions of the region 110 having sufficient physical extent to correspond to body parts or an entire body of a person 112, and remove features corresponding to smaller objects such as small animals, leaves of plants, or other clutter. According to an embodiment, the spatial filter may remove information corresponding to areas of contrast, velocity, or frequency component(s) having physical extent greater than a maximum angle or extent that is likely to correspond to a person or persons 112. In other embodiments, the spatial filter applied in step 206 may eliminate small, low contrast features, but retain small, high contrast features such as jewelry, since such body ornamentation may be useful in some subsequent processes. The step of applying the spatial filter 206 may further include removing background features from the MIR data. For example, a wall lying between an antenna 104, 114 and the region 110 may cast a shadow such as a line in every MIR signal. Removal of such constant features may reduce subsequent processing requirements.

Proceeding to optional step 208, an edge-finder may identify edges of objects 112 in the region 110. For example, a global threshold, local threshold, second derivative, or other algorithm may identify edge candidates. Object edges may be used, for example, to identify object shapes, and thus relieve subsequent processes from operating on grayscale data. Alternatively, step 208 may be omitted and the process of identifying objects may be performed on the grayscale MIR data.

Proceeding to step 210, processed data corresponding to the MIR data is compared to a database to determine a match. The object data received from step 202 (and optionally steps 204, 206, and/or 208) may be compared to corresponding data for known objects in a shape database. Step 210 may be performed on a grayscale signal, but for simplicity of description it will be assumed that optional step 208 was performed and matching is performed using object edges, velocity, and/or spectrum values. For example, the edge of an object 112 in the region 110 may include a line corresponding to the outline of the head and torso, cardiac spectrum, and movements characteristic of a young adult male. A first shape in the shape database may include the outline of the head and torso, cardiac spectrum, density, and movements characteristic of a young adult female and/or the head and torso outline, cardiac spectrum, density, and movements characteristic of a generic human. The differences between the MIR data and the shape database shape may be measured and characterized to derive a probability value. For example, a least-squares difference may be calculated.

Optionally, the object shape from the MIR data may be stepped across, magnified, and stepped up and down the shape database data to minimize a sum-of-squares difference between the MIR shape and the first shape in the shape database. The minimum difference corresponds to the probability value for the first shape.

Proceeding to step 212, if the probability value for the first shape is the best probability yet encountered, the process proceeds to step 214. For the first shape tested, the first probability value is the best probability yet encountered. If an earlier tested shape had a higher probability to the MIR data, the process loops back from step 212 to step 210 and the fit comparison is repeated for the next shape from the shape database.

In step 214, the object type for the compared shape from the shape database and the best probability value for the compared shape are temporarily stored for future comparison and/or output. For example, the compared shape from the shape database may be identified by metadata that is included in the database or embedded in the comparison data. Proceeding to step 216, the process either loops back to step 210 or proceeds to step 218, depending on whether a test is met. If the most recently compared shape is the last shape available for comparison, then the process proceeds to step 218. Optionally, if the most recently compared shape is the last shape that the process has time to compare (for example, if a new MIR data is received and/or if another process requires output data from the process 201) then the process proceeds to step 218. In step 218, the object type and the probability value is output. The process may then loop back to step 202 and the process 201 may be repeated.

Otherwise, the process 201 loops from step 216 back to step 210. Again, in step 210, the next comparison shape from a shape database is loaded. According to an embodiment, the comparison may proceed from the last tested shape in the shape database. In this way if the step 218 to 202 loop occurs more rapidly than all objects in the shape database may be compared, the process eventually works its way through the entire shape database. According to an embodiment, the shape database may include multiple copies of the same object at different orientations, distances, and positions within the region. This may be useful to reduce processing associated with stepping the MIR shape across the shape database shape and/or changing magnification.

The object type may include determination of a number of persons 112 in the region 110. For example, the shape database may include outlines, cardiac and/or respiration spectra, density, and movement characteristics for plural numbers of persons. According to embodiments, the shape library may include shapes not corresponding to persons. This may aid in identification of circumstances where no person 212 is in the region 210. Optionally, process 201 may be performed using plural video frames such as averaged video frames or a series of video frames. Optionally, steps 212, 214, and 216 may be replace by a single decision step that compares the probability to a predetermined value and proceeds to step 218 if the probability meets the predetermined value. This may be useful, for example, in embodiments where simple presence or absence of a person 212 in the region 210 is sufficient information.

According to an embodiment, the signal analysis process 201 of FIG. 2 may be performed using conventional software running on a general-purpose microprocessor. Optionally, the process 201 using various combinations of hardware, firmware, and software and may include use of a digital signal processor.

FIG. 3 is a flow chart showing an illustrative process 301 for determining one or more particular physiological parameters of a person 112 in the region 110 with the signal analyzer 124 of the MIR 101, according to an embodiment. Optionally, the process 301 of FIG. 3 may be performed conditional to the results of another process such as the process 201 of FIG. 2. For example, if the process 201 determines that no person 112 is in the region 110, then it may be preferable to continue to repeat process 201 rather than execute process 301 in an attempt to extract one or more particular physiological parameters from a person that is not present.

Beginning with step 302, a series of MIR time series data is received. While the received time series data need not be purely sequential, the process 301 generally needs the time series data received in step 302 to have a temporal capture relationship appropriate for extracting time-based information. According to an embodiment, the MIR time series data may have a frame rate between about 16 frames per second and about 120 frames per second. Higher capture rate systems may benefit from depopulating frames, such as by dropping every other frame, to reduce data processing capacity requirements.

Proceeding to step 304, the MIR video frames may be enhanced in a manner akin to that described in conjunction with step 204 of FIG. 2. Optionally, step 304 may include averaging and/or smoothing across multiple MIR time series data. Proceeding to optional step 306, a frequency filter may be applied. The frequency filter may operate by comparing changes between MIR time series data to a reference frequency band for extracting a desired physical parameter. For example, if a desired physiological parameter is a heart rate, then it may be useful to apply a pass band for periodic movements having a frequency between about 20 cycles per minute and about 200 cycles per minute, since periodic motion beyond those limits is unlikely to be related to a human heart rate. Alternatively, step 304 may include a high pass filter that removes periodic motion below a predetermined limit, but retains higher frequency information that may be useful for determining atypical physiological parameters.

Proceeding to optional step 308, a spatial filter may be applied. The spatial filter may, for example, include a pass band filter configured to remove information corresponding to areas of contrast having insufficient physical extent to be large enough to be an object of interest, and remove information corresponding to areas too large to be an object of interest. The spatial filter may, for example, identify portions of the region 110 having sufficient physical extent to correspond to the heart, diaphragm, or chest of a person 112, and remove signal features corresponding to smaller or larger objects. The step of applying the spatial filter 308 may further include removing background features from the MIR data. For example, a wall lying between an antenna 104, 114 (114b) and the region 110 may cast a shadow such as a line in every instance of MIR data. Removal of such constant features may reduce subsequent processing requirements.

Proceeding to step 310, movement such as periodic movement in the MIR time series data is measured. For example, when a periodic motion is to be measured, a time-to-frequency domain transform may be performed on selected signal elements. For example, when a non-periodic motion such as translation or rotation is to be measured, a rate of movement of selected signal elements may be determined. Optionally, periodic and/or non-periodic motion may be measured in space vs. time. Arrhythmic movement features may be measured as spread in frequency domain bright points or may be determined as motion vs. time. Optionally, subsets of the selected signal elements may be analyzed for arrhythmic features. Optionally plural subsets of selected signal elements may be cross-correlated for periodic and/or arrhythmic features. Optionally, one or more motion phase relationships between plural subsets of selected signal features, between a subset of a selected signal feature and the signal feature, or between signal features may be determined.

For example, a person with a hiccup may be detected as a non-periodic or arrhythmic motion superimposed over periodic motion of a signal element corresponding to the diaphragm of the person.

Proceeding to step 312, a physiological parameter can be calculated. For example, MIR data can include data having a periodic motion spectrum corresponding to the location characteristic of a human physiological process (e.g. heartbeat and/or breathing). Step 312 can include determining one or more heart rates by comparing movement of the heart surface to the MIR signal rate. The one or more heart rates can further be characterized according to a confidence factor, depending on statistical certainty regarding the determined one or more heart rates. Similarly, step 312 can include determining one or more respiration rates by measuring movement corresponding to the chest or diaphragm of one or more persons.

Proceeding to step 314, the physiological parameter can be output. Proceeding to step 316, if there are more locations to measure, the process 301 can loop back to execute step 308. If there are not more locations to measure, the process can proceed to step 318. In step 318, if there are more physiological parameters to measure, the process 301 can loop back to execute step 306. If there are not more physiological parameters to measure, the process 301 can loop back to step 302, and the process 301 of FIG. 3 can be repeated.

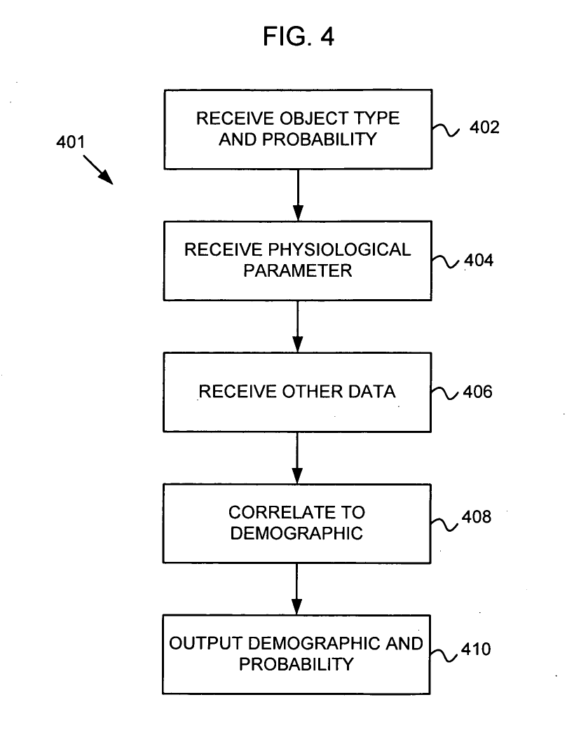

FIG. 4 is a flow chart showing an illustrative process 401 for determining a demographic of a person 112 in the region 110 with the signal analyzer 124 of the MIR 101, according to an embodiment. Beginning in step 402, the process 401 receives an object type, and optionally a probability for an object in a region 110. For example, the object type and probability may be received from a process such as the process 201 shown in FIG. 2. For example, the object type may include a person having a size and body structure. Proceeding to step 404, the process 201 receives one or more particular physiological parameters corresponding to the person 112. For example, the one or more particular physiological parameters may be received from a process such as the process 301 shown in FIG. 3. For example, the one or more physiological parameters may be correlated to one or more persons in the region 110. Proceeding to optional step 406, the process 401 may receive other data that may be used to aid in correlating the information received in steps 402 and 404 to a demographic. For example, the other data may include data not extracted from MIR interrogation of the region 110. Other data may include one or more of a time, a day, a date, a temperature, a humidity, location, an ambient light level, or an ambient sound level, for example.

Proceeding to step 408, the data received in steps 402, 404, and optionally 406 is correlated to a demographic. For example, the object type and probability may include (optionally for each of a plurality of persons 112 in the region 110) an indication of human size and gender (if determined), along with a probability value indicative of a degree of certainty with respect to size and gender designation. Optionally, the object 112 type may include a location and/or deduced relative orientation (direction faced) within the region 110. The particular physiological parameter may include one or more physiological parameters such as a heart rate and regularity and a respiration rate and regularity.

Meeting a demographic can include, for example, meeting selected population characteristics as used in government, marketing or opinion research, or the demographic profiles used in such research. Commonly-used demographics include race, age, disabilities, location, gender, and the like. Meeting a demographic may include a positive or a negative relationship. For example, a demographic may be a positive relationship such as people between 5′3″ and 5′7″. Alternatively, a demographic may include a negative relationship such as people who are not between 5′3″ and 5′7″. Meeting one or more demographics can be a Boolean-type event such as “Demographic 1 AND Demographic 2”, “Demographic 1 OR Demographic 2”, “Demographic 1 AND (Demographic 2 OR Demographic 3)”, etc.

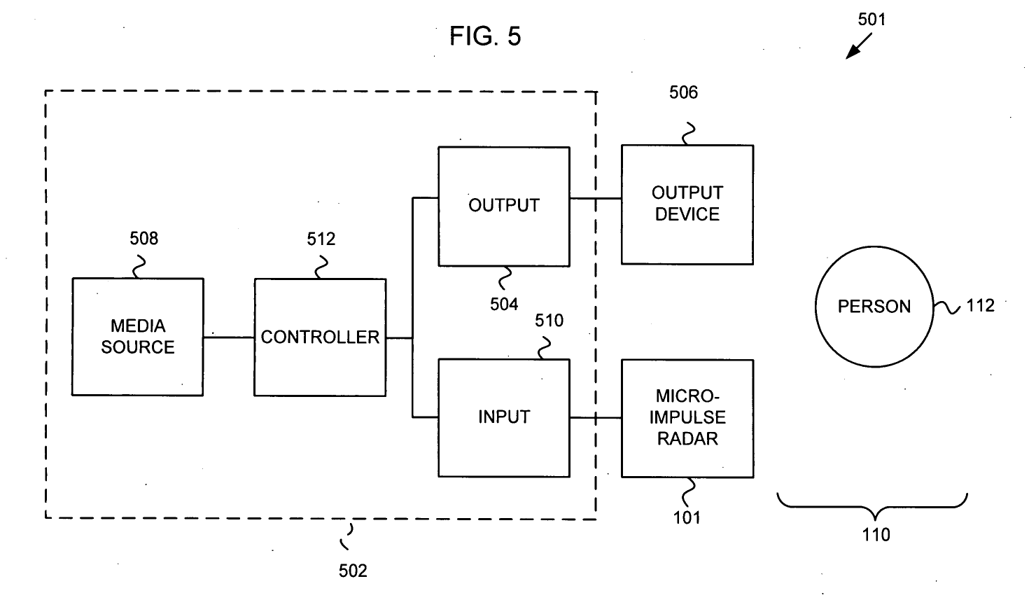

FIG. 5 is a block diagram of a system 501 for delivering media content to a target demographic, according to an embodiment.

According to an embodiment, a control module 502 for an adaptive media delivery system may include a media download port 508 configured to receive media files or media streams from a network, a display drive port 504 configured to drive one or more media displays 506, a media delivery controller 512 operatively coupled to the media source configured as a media download port 508 and the display drive port 504, and a MIR 101 or a signal input configured as a MIR port 510 configured to provide data related to at least one viewer or potential viewer 112 to the media delivery controller 512.

According to an embodiment, the system 501 may include a control module 502 having a signal output 504 configured to operatively couple to an output device 506. A media source 508 may be configured to provide media content targeted at one or more human demographics. A signal input 510 may be configured to operatively couple to a MIR 101. The MIR 101 may be configured to probe one or more persons 112 in a region 110 proximate to the output device 506.

An electronic controller 512 is operatively coupled to the signal output 504, the media source 508, and the signal input 510. The electronic controller 512 may be configured to determine if data or a MIR signal received from the signal input 510 corresponds to one or more persons 112 meeting at least one demographic.

For example, the MIR 101 may include a signal processor 120 and/or signal analyzer 124 (shown in FIG. 1) configured to perform processing related to demographic determination; such as by using the processes 201, 301, and/or 401 respectively shown in FIGS. 2, 3, and 4; and provide demographic data to the signal input 510.

Alternatively, the MIR 101 may provide MIR data to the signal input 510, and the electronic controller 512 may perform signal analysis processes to determine at least one demographic based on the MIR data. For example, the electronic controller 512 may determine demographic information according to the processes 201, 301, and/or 401. Alternatively, processes to determine demographic information may be distributed between the MIR 101 and the module 502. Optionally, one or more portions of the module 502 may be embodied as portions of the MIR 101.

The at least one demographic may include one or more physiological parameters. The electronic controller 512 and/or the MIR 101 may be configured to determine physiological information from the MIR signal. Demographic data may be determined from one or more of a size of a person, a shape of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons in the region, accompaniment by at least one child, location of one or more persons in the region; proximity of two or more persons in the region to one another, orientation of one or more persons in the region relative to a media output device, direction of motion, speed of motion, location of one or more persons relative to the media output device, presence of obstructions between one or more persons and the media output device, residence time of person within the region, or accompaniment by at least one animal. Demographic data and/or media selection logic may include a number of persons 112 in the region 110. Media selection may be made according to one or more persons 112 in the region 110 meeting a plurality of target demographics.

Selection of media may include logic for prohibiting selection of one or more media files or streams if a person corresponding to one or more demographics is present in the region. For example, a media stream corresponding to a cigarette advertisement may be prohibited from playing if a child is in the region.

Media selection may be made according to demographics not included in the region 112, Boolean relationships of demographics included in the region 112, demographic ranges included in the region 112, or demographic ranges not included in the region 112.

For example, the one or more demographics may include a grouping of persons having a similar trait or a grouping of persons not having a similar trait. The one or more demographics may similarly include a plurality of groupings of persons having similar respective traits or a plurality of groupings of persons not having the similar respective traits. The one or more demographics may include one or more groupings of persons having similar traits and not having other similar traits.

The electronic controller 512 may be configured to determine at least one of a time, a day, a date, a temperature, a humidity, a location, an ambient light level, and/or an ambient sound level. Media selection logic may be responsive to at least one of the time, the day, the date, the temperature, the humidity, the location, the ambient light level, and/or the ambient sound level.

The electronic controller 512 may be configured to read a metadata file including target demographic metadata corresponding to available media content and select media content responsive to a match between the metadata and the determined demographic. For example, available media content may be held in a plurality of media files or streams. The electronic controller 512 may be configured to select a media file or stream from the media source 508 by comparing the determined demographic data to metadata embedded in media file headers or packet headers.

The media source 508 may provide a plurality of media files or streams corresponding to a given demographic, a media file or stream that corresponds to a plurality of demographics, and/or a plurality of media files or streams that correspond to a plurality of demographics. Accordingly, the electronic controller 512 may include media file or media stream selection logic configured to select for output one or more media files or streams from a plurality of media files or streams corresponding to the target demographic. For example, the selection logic is configured to select the one or more media files or streams from the plurality of media files or streams according to one or more of a demographic score, a randomizer, a circular buffer, a contractual obligation, and/or an output interval. That is, a demographic score such as a confidence factor and/or conformance to plural demographics may be matched to a media file or stream that best matches the confidence factor or that is designated for plural demographics that best match the plural demographics determined during MIR data analysis. Additionally or alternatively, media files or streams corresponding to determined demographics may be selected randomly, which may be implemented as a pseudo-random selection logic. Additionally or alternatively, media files or streams may be selected according to the longest time duration since the media file or stream was last played, a logic that may be implemented as a circular buffer, for example. Additionally or alternatively, a given media file or stream may be selected according to a desired output interval and/or a contractual obligation. For example, an advertiser may pay a fee to ensure that a media file or stream is output at least once every four hours and/or that the media file or stream be given preference over other media files or streams that also meet one or more detected demographics.

The media source 508 may include a computer storage medium configured to hold a plurality of media files. The electronic controller 512 may be configured to compare the demographic of the at least one person 112 in the region 110 to demographic information embedded in a media file, and select the media file if the demographic matches the embedded demographic information.

The media source 508 may include a network interface configured to receive a plurality of media channels. The electronic controller may be configured to subscribe to a multicast media channel corresponding to a least one demographic met by the at least one person.

Media content may include an advertisement, entertainment, news, data, software, or information, for example.

According to an embodiment, the electronic controller 512 may be further configured to record demographics and output media content. For example, media content providers may be billed fees according to the number of times media is output and according to the match between media output instances and corresponding demographics. According to an embodiment, a media content provider may be billed a fee corresponding to the number of persons 112 and/or persons 112 meeting one or more demographics to which provided media content is output.

According to an embodiment, the electronic controller 512 may include media file selection logic responsive to an orientation or location relative to the output device 506 of one or more persons meeting the target demographic.

For example, the signal output may be configured to couple to a plurality of output channels 504. The electronic controller 512 may be configured to select an output channel 504 responsive to at least one of orientation or location of at least one person 112 in the region 110. The output channels 504 may include at least one video output channel and at least one audio output channel. An output device 506 may include a video display such as a screen or a portable video player or an audio player such as a speaker or portable audio player. The portable audio player may be addressed by virtue of an ad hoc network determined according to proximity, for example.

The electronic controller 512 may be configured to control an output device 506 attribute responsive to an orientation or location of at least one person 112 relative to the output device 506. For example, an output device 506 attribute may include video resolution, video magnification, video color, video brightness, video sharpness, audio volume, audio channel separation, and/or audio compression.

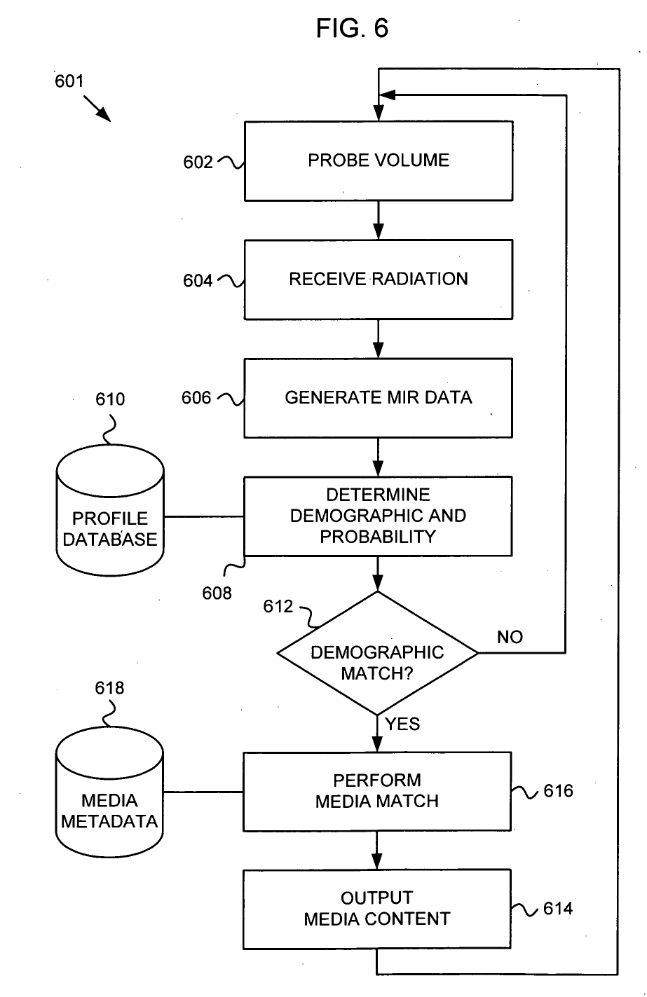

FIG. 6 is a flow chart illustrating a method 601 for delivering media content to at least one person having a target demographic, according to an embodiment. The method 601 begins at step 602, wherein a region is probed with a series of micro-impulses from a MIR antenna 104. Proceeding to step 604, radiation scattered from the pulse is received by a MIR antenna 114 and receiver 118. Next, in step 606, MIR data is generated from the received radiation. For example, the data may be generated according to approaches described in conjunction with FIG. 1.

Proceeding to step 608, a demographic and probability are determined. For example, received MIR data characteristics may be compared to corresponding characteristics in a demographic profile database 610. The degree to which the MIR data characteristics match corresponding characteristics in the demographic profile database 610 may determine the probability. For example, the probability may be calculated as the extent to which received MIR data characteristics correlate to characteristics of a target demographic according to approaches described in conjunction with FIGS. 2 and 3.

The process 601 may then proceed to step 612, where the probability determined in step 608 may be compared to one or more criteria forming a predetermined value. If the probability is equal to or greater than the predetermined value, the process may proceed to step 614, wherein human-perceptible media content is output to the region 110 and one or more persons 112 in the region. For example, the human-perceptible media content may include an advertisement, entertainment, news, or information targeted to a target demographic determined and qualified in step 308. If there is not a demographic match, as determined by the probability meeting the predetermined value in step 612, the process 601 may loop back to step 602 where the MIR 101 again probes the region. Similarly, if there is a demographic match and human-perceptible media content is output to the region in step 614, the process 601 may loop back to step 602. Step 602 may then commence before or after conclusion of outputting the human-perceptible media content. If looped-to steps 602, 604, 606, and 608 are finished prior to outputting the human perceptible media content, the output step 614 may be modified depending on the result. For example, if the person 112 meeting the target demographic has moved out of the region 110 to which the media content is played, then step 614 may be stopped.

Outputting human-perceptible media content in step 614 may, for example, include driving a video display such as a display screen, driving a video display such as a portable video player, driving an audio player such as a loudspeaker, or driving an audio player such as a portable audio player. Thus, output may include driving a substantially fixed apparatus or may include establishing a data channel and outputting the human-perceptible media content through a portable device carried by the person.

According to an embodiment, the system may charge to a media content provider a fee corresponding to a number of persons meeting the target demographic to which the media content is played. Such billing may be based on media output instances initiated or on media output instances completed. Referring back to FIG. 5, the controller 512 may maintain a record of media output instances initiated and completed, or alternatively may immediately report such events to an external resource (not shown).

Referring to step 608, determining from the received MIR radiation a probability of the region 110 including one or more persons 112 having the target demographic may include determining at least one physiological parameter. According to an embodiment, determining from the scattered MIR signal a probability of the region 110 including one or more persons 112 having the target demographic may include determining a size of a person 112, a shape of a person 112, detectable ornamentation associated with a person 112, detectable clothing worn by a person 112, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons 112 in the region 110, accompaniment by at least one child 112, location of one or more persons 112 in the region 110; proximity of two or more persons 112 in the region 110 to one another, orientation of one or more persons 112 in the region 110 relative to a media output device, or accompaniment by at least one animal 112. For example, the demographic may include at least one of gender, age group, detectable health, hunger, child caregiver, or animal owner.

According to an embodiment, the target demographic may include a plurality of target demographics. In such embodiments, the process 602 may further include step 616 wherein media content is selected according to the demographic and probability determined in step 608. For example, step 616 may include selecting at least one of a plurality of media contents responsive to determining a probability of a particular target demographic.

For example, selecting at least one of a plurality of media contents may include selecting at least one media file from a computer storage medium. According to another example, selecting at least one of a plurality of media contents may include selecting at least one of a plurality of media channels cumulatively or selectively received by a network interface.

The media content may be selected responsive to a number of persons 112 in the region 110. For example, if media content includes a personal hygiene advertisement, such output may be suppressed if a group of persons are present in the region. Similarly, media content may be selected responsive to a plurality of demographics corresponding to persons in the region 110. For example, if an adult alone is determined to be in the region 110, media content may include mature content; but if an adult is accompanied by a child, then the output of mature media content may be suppressed.

The media content may be selected responsive to at least one of a time, a day, a date, a temperature, a humidity, a location, an ambient light level, or an ambient sound level. For example, if the target demographic includes an adult couple having a probability for eating (e.g. two persons, adult size, time-of-day corresponding to lunch), an advertisement for a lunch at a nearby restaurant may be output. Conversely, a different advertisement, such as an advertisement for dinner, may be output if the time is an evening time. If the day corresponds to a day that the advertising restaurant is closed, output of advertising for the restaurant may be suppressed (for example, in favor of different media content), or an awareness advertisement may be output to promote a future visit. Output may be selected based on a detectable relationship between persons (e.g., if in close proximity to one another, promote a romantic dinner environment; if at social distance apart, promote a business dinner environment; etc.)

According to embodiments, media selection may be based on comparing media metadata to the determined demographic. For example, media metadata 618 may include a metadata file, or may include embedded metadata. For example, step 616 may include reading a metadata file 618 including target demographic metadata corresponding to available media content, and selecting media content responsive to a match between the metadata and the determined target demographic. Alternatively, step 616 may include selecting between media files or streams where the metadata is embedded, such as by comparing metadata embedded in media file headers or packet headers to the determined demographic and selecting a media file or media stream responsive to a match between the metadata and the determined target demographic.

Step 608 may include determining from the scattered MIR radiation a location or orientation of one or more persons 112 in the region 110. Step 616 may include selecting media content responsive to the orientation or location of the one or more persons 112. Step 608 may include determining from the scattered MIR data a location or orientation of one or more persons relative to at least one perceptible media content output device. Step 614 may include selecting at least one media content output device for outputting the media content responsive to the orientation or location of at least one person relative to the media content output device. Step 614 may include controlling an output device attribute responsive to orientation and/or location of the at least one person. For example, an output device attribute such as video resolution, video magnification, video color, video brightness, video sharpness, audio volume, audio channel separation, and/or audio compression may be controlled during step 614 responsive to the location and/or orientation of at least one person detected and demographically identified by steps 602-608 and 612.

Step 614 may include subscribing to a multicast media channel to receive media content corresponding to a least one demographic met by the at least one person. Step 614 may include outputting signage, outputting a signal, outputting audio, outputting video, and/or outputting audio/video content, for example.

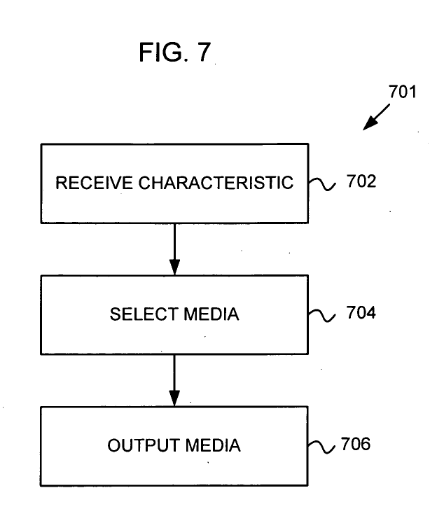

FIG. 7 is a simplified flow chart showing a method 701 for providing selected information to one or more persons 112, according to an embodiment. In step 702 information is received from a MIR, the information corresponding to one or more characteristics of one or more persons 112 in a region 110. Proceeding to step 704, media is selected based on the characteristics. Step 704 may represent a simple yes/no decision in embodiments where particular media is to be delivered to persons having a target characteristic. Step 704 may alternatively represent more complex demographic and media matching, as described above. Proceeding to step 706, media, for example, human perceptible media, is output to the region 110 responsive to the one or more characteristics.

For example, information corresponding to one or more characteristics may include information corresponding to one or more of a size of a person, a shape of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons in the region, accompaniment by at least one child, location of one or more persons in the region, proximity of two or more persons in the region to one another, orientation of one or more persons in the region relative to a media output device, direction of motion, speed of motion, location of one or more persons relative to the media output device, presence of obstructions between one or more persons and the media output device, residence time of person within the region, or accompaniment by at least one animal. In step 704, one or more sets of media content corresponding to the one or more characteristics may be selected for output. For example, outputting media may include outputting signage, outputting a signal, outputting audio, outputting video, or outputting audio/video content.

According to an embodiment, the MIR may be configured to provide a signal corresponding to the region 110. According to an embodiment, the MIR may be configured to provide a time series of data corresponding to the region 110. According to an embodiment, the MIR may be configured to capture and analyze a signal or series of signals corresponding to the region 110 and provide a signal analysis result.

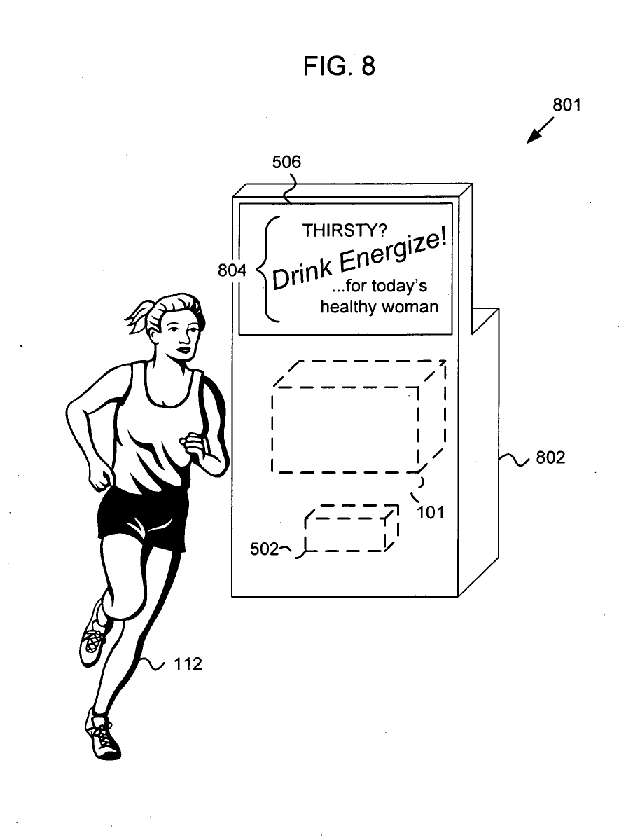

FIG. 8 illustrates an arrangement 801 for providing media targeted to persons 112 in a region 110 that may include a public space, according to an embodiment. A housing 802, such as a kiosk or the like, may include a media output device 506 such as a display configured to output media content 804 to a viewing region. A MIR 101 may be configured to probe an examination region 110 and generate an output signal. A controller or control module 502 may be configured to receive the output signal, determine one or more human demographics in the viewing region, and responsively select media content 804 for output via the media output device 506. According to an embodiment, the housing 802 may substantially enclose the media output device 506, micro-impulse radar 101, and controller or control module 502. The media output device 506 may, for example, include a selectable sign, an audio output, a video display, and/or an audio/video display.

The viewing region 110 and the examination region (not shown) may be substantially overlapping, such as where receive antennas (not shown) of the micro-impulse radar 101 are aligned to receive scattered radiation from an area in front of a media display 506. Alternatively, the micro-impulse radar 101 may be operatively coupled to probe an examination region that does not necessarily overlap the viewing region 110. For example, if human traffic typically proceeds from left-to-right past the housing 802, the micro-impulse radar 101 may be configured to probe an examination region to the left of the media display 506, or the examination region may include a portion to the left of the media display 506. This arrangement may provide processing time to select a message such that the selected message is already displayed as the person 112 moves past the media display 506. The examination region may be adjacent to and/or abut to viewing region 110. Alternatively, the examination region may be separated from the viewing region 110. Optionally, the controller or control module 502 may include a media queue corresponding to a plurality of persons moving from the examination region to the viewing region. In this way, media may be selected according to one or more demographics corresponding to one or more persons as the one or more persons enters or is in the viewing region 110.

The micro-impulse radar 101 and/or the controller or control module 502 may be configured to detect and include in the output signal information corresponding to one or more of a size of a person, a shape of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons in the region, accompaniment by at least one child, location of one or more persons in the region, proximity of two or more persons in the region to one another, orientation of one or more persons in the region relative to a media output device, direction of motion, speed of motion, location of one or more persons relative to the media output device, presence of obstructions between one or more persons and the media output device, residence time of person within the region, or accompaniment by at least one animal. According to an embodiment, the controller or control module 502 may be configured to determine the one or more human demographics from the information detected by and included in the output signal of the micro-impulse radar.

The controller or control module 502 may be configured to select media content for display by subscribing to a media multicast or reading one or more stored media files targeted at the one or more human demographics.

Portions of the control, demographic determination, media selection, output device drive, MIR data receipt, probed pulse signal processing, and/or MIR signal processing may be performed by a general purpose computer. For example, structures, functions, and or method steps may correspond to computer-executable instructions carried on a tangible computer readable medium.

According to an embodiment, a tangible computer readable medium carrying computer-executable instructions may be configured to cause a computer to receive micro-impulse radar data, determine at least one human demographic from the micro-impulse radar data, and select for output media content as a function of the human demographic. The instructions may further cause the computer to prohibit output of media content not suitable for at least one determined human demographic. The instructions may further cause the computer to drive a media output device to output the selected media content. The instructions may cause the computer to drive at least one of a video display, an audio output, a selectable sign, and/or an audio/video display.

The tangible computer readable medium carrying computer-executable instructions for selecting media content for output may include instructions to cause the computer to make an operative coupling to a media download port configured to receive media files or media streams from a network. Additionally or alternatively, selecting media content may include reading one or more media files from at least one computer readable storage medium.

Optionally the computer-executable instructions for receiving micro-impulse radar data may cause the computer to receive reflected pulse waveforms and perform signal processing on the received reflected pulse waveforms. Alternatively, receiving micro-impulse radar data may include receiving processed data from a micro-impulse radar signal processor.

While particular aspects of the present subject matter described herein have been shown and described, it will be apparent that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A system for delivering media content to one or more target demographics, comprising:
an output port configured to drive a media output device;
a media source configured to provide media content targeted at one or more human demographics;
micro-impulse radar configured to output micro-impulse radar data corresponding to persons in a region proximate to the output device; and
an electronic controller operatively coupled to the output device, the media source, and the micro-impulse radar, and configured to determine if the micro-impulse radar data corresponds to one or more persons meeting the one or more demographics, and if a person in the region meets at least one demographic, drive the signal output to output the at least one media content targeted at the demographic.

2. The system for delivering media content to one or more target demographics of claim 1, wherein the micro-impulse radar is configured to deliver demographic data to the electronic controller.

3. The system for delivering media content to one or more target demographics of claim 1, wherein the electronic controller is configured to perform signal analysis to determine at least one demographic of the person in the region.

4. The system for delivering media content to one or more target demographics of claim 3, wherein the electronic controller is further configured to determine physiological information from the micro-impulse radar data, and where the at least one demographic includes a physiological parameter.

5. The system for delivering media content to one or more target demographics of claim 1, wherein the media content is provided as one or more media files, one or more media streams, or one or more media files and one or more media streams.

6. The system for delivering media content to one or more target demographics of claim 1, wherein the micro-impulse radar is configured to perform signal analysis to determine one or more demographics of one or more persons in the region and provide demographic data to the electronic controller.

7. The system for delivering media content to one or more target demographics of claim 1, wherein the at least one demographic includes at least one physiological parameter.

8. The system for delivering media content to one or more target demographics of claim 1, wherein at least one demographic is determined from at least one of a size of a person, a shape of a person, density of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a person appliance, a number of persons in the region, accompaniment by at least one child, location of one or more persons in the region; proximity of two or more persons in the region to one another, orientation of one or more persons in the region relative to a media output device, direction of motion, speed of motion, location of one or more persons relative to the media output device, presence of obstructions between one or more persons and the media output device, residence time of person within the region, or accompaniment by at least one animal.

9. The system for delivering media content to one or more target demographics of claim 1, wherein the electronic controller includes media selection logic responsive to a number of persons in the region.

10. The system for delivering media content to one or more target demographics of claim 1, wherein the electronic controller includes media selection logic responsive to persons meeting a plurality of demographics in the region.

11. The system for delivering media content to one or more target demographics of claim 1, wherein the electronic controller includes media selection logic responsive to a number of persons meeting the target demographic in the region.

12. The system for delivering media content to one or more target demographics of claim 1, wherein the electronic controller includes media selection logic configured to select for output one or more media files or streams from a plurality of media files or streams corresponding to the target demographic.

13. The system for delivering media content to one or more target demographics of claim 12, wherein the selection logic is configured to select the one or more media files or streams from the plurality of media files or streams according to one or more of a demographic score, a randomizer, a circular buffer, a contractual obligation, or an output interval.

14. The system for delivering media content to one or more target demographics of claim 1, wherein the one or more demographics includes at least one of a grouping of persons having a similar trait, a grouping of persons not having a similar trait, a plurality of groupings of persons having similar respective traits, a plurality of groupings of persons not having the similar respective traits, or one or more groupings of persons having similar traits and not having other similar traits.

15. The system for delivering media content to one or more target demographics of claim 1, wherein the electronic controller is configured to determine at least one of a time, a day, a date, a temperature, a humidity, a location, an ambient sound level, or an ambient light level; and
wherein the electronic controller includes media file selection logic responsive to at least one of the time, the day, the date, the temperature, the humidity, the location, the ambient sound level, or the ambient light level.

16. The system for delivering media content to one or more target demographics of claim 1, wherein the electronic controller is configured to read a metadata file including target demographic metadata corresponding to available media content and select media content responsive to a match between the metadata and the determined demographic.

17. The system for delivering media content to one or more target demographics of claim 1, wherein available media content is held in a plurality of media files or streams; and
wherein the electronic controller is configured to select a media file or stream by comparing metadata embedded in media file headers or packet headers.

18. The system for delivering media content to one or more target demographics of claim 1, wherein the media source includes a computer storage medium configured to hold a plurality of media files.

19. The system for delivering media content to one or more target demographics of claim 1, wherein the electronic controller is configured to compare the demographic of the at least one person in the region to demographic information embedded in a media file, and select the media file if the demographic matches the embedded demographic information.

20. The system for delivering media content to one or more target demographics of claim 1, wherein the electronic controller is configured to determine the demographic of the at least one person in the region and prohibit selection of one or more media files or streams responsive to the determined demographic.

21. The system for delivering media content to one or more target demographics of claim 1, wherein the media source includes a network interface configured to receive a plurality of media channels.

22. The system for delivering media content to one or more target demographics of claim 21, wherein the electronic controller is configured to subscribe to a multicast media channel corresponding to a least one demographic met by the at least one person.

23. The system for delivering media content to one or more target demographics of claim 1, wherein the media content includes an advertisement, entertainment, news, software, data, or information.

24. The system for delivering media content to one or more target demographics of claim 1, wherein the electronic controller is further configured to record demographics and output media content.

25. The system for delivering media content to one or more target demographics of claim 1, wherein the electronic controller includes media file selection logic responsive to an orientation relative to the output device of one or more persons meeting the demographic.

26. The system for delivering media content to one or more target demographics of claim 1, wherein the signal output is configured to couple to a plurality of output channels; and
wherein the electronic controller is configured to select an output channel responsive to at least one of orientation or location of at least one person in the region.

27. The system for delivering media content to one or more target demographics of claim 26, wherein the output channels include at least one video output channel and at least one audio output channel.

28. The system for delivering media content to one or more target demographics of claim 1, further comprising:
an output device including a video display.

29. The system for delivering media content to one or more target demographics of claim 1, further comprising:
an output device including an audio player.

30. The system for delivering media content to one or more target demographics of claim 1, wherein the electronic controller is configured to control an output device attribute responsive to at least one of orientation or location.

31. The system for delivering media content to one or more target demographics of claim 30, wherein the output device attribute includes at least one of video resolution, video magnification, video color, video brightness, video sharpness, audio volume, audio channel separation, or audio compression.

32. The system for delivering media content to one or more target demographics of claim 1, wherein the electronic controller is configured to select media content for output as a function of a time history of micro-impulse radar data.

33. The system for delivering media content to one or more target demographics of claim 1, wherein the micro-impulse radar includes a single receive antenna.

34. The system for delivering media content to one or more demographics of claim 1, wherein the micro-impulse radar includes a plurality of transmit antennas, a plurality of receive antennas, or a plurality of transmit and receive antennas.

35. The system for delivering media content to one or more demographics of claim 1, wherein micro-impulse radar includes a plurality of antennas configured to interrogate the region from a plurality of orientations.

36. The system for delivering media content to one or more demographics of claim 35, wherein the demographic data is determined from a plurality of orientations corresponding to a plurality of antennas.

37. The system for delivering media content to one or more demographics of claim 1, wherein the demographic data is determined from a plurality of ranges of data provided by the micro-impulse radar.

38. The system for delivering media content to one or more demographics of claim 1, wherein the micro-impulse radar includes:
a pulse generator configured to generate electromagnetic pulses;
a transmit antenna operatively coupled to the pulse generator and configured to output micro-impulse radar probe pulses into the region;
at least one receive antenna, separate or combined with the transmit antenna, configured to receive scattered signals from the probe pulses;
at least one receiver operatively coupled to the at least one receive antenna; and
a signal processor configured to receive probe signals from the at least one receiver and generate micro-impulse radar data corresponding to the one or more persons in the region.

39. The system for delivering media content to one or more demographics of claim 1, wherein the micro-impulse radar data corresponds to one or more of spatial information, time-domain motion information, and frequency domain information.

40. The system for delivering media content to one or more demographics of claim 1, wherein the micro-impulse radar data includes data in the form of an image.

41. The system for delivering media content to one or more demographics of claim 40, wherein the micro-impulse radar data in the form of an image corresponds to one or more of a surface slice made of pixels, a volume made of voxels, or vector information.

42. A method for delivering media content to at least one person corresponding to a target demographic, comprising:
probing a region with a micro-impulse radar;
receiving scattered micro-impulse radar radiation from the region with a receiver;
generating micro-impulse radar data from the received scattered micro-impulse radar radiation;
determining from the micro-impulse radar data a probability of the region including one or more persons corresponding to a target demographic; and
outputting human perceptible media content to the region if the probability is equal to or greater than a predetermined value.

43. The method for delivering media content to at least one person corresponding to a target demographic of claim 42, wherein probing the region with a micro-impulse radar includes probing the region with a series of micro impulses.

44. The method for delivering media content to at least one person corresponding to a target demographic of claim 42, wherein the micro-impulse radar data includes a micro-impulse radar image.

45. The method for delivering media content to at least one person corresponding to a target demographic of claim 44, wherein the micro-impulse radar image includes a planar image including pixels, a volumetric image including voxels, or a vector image.

46. The method for delivering media content to at least one person corresponding to a target demographic of claim 42, wherein the human-perceptible media content includes an advertisement, entertainment, news, data, software, or information.

47. The method for delivering media content to at least one person corresponding to a target demographic of claim 42, further comprising:
charging to a media content provider a fee corresponding to a number of persons meeting the demographic to which the media content is played.

48. The method for delivering media content to at least one person corresponding to a target demographic of claim 42, wherein determining from the micro-impulse radar data a probability of the region including one or more persons corresponding to the target demographic includes determining at least one physiological parameter.

49. The method for delivering media content to at least one person corresponding to a target demographic of claim 42, wherein determining from the micro-impulse radar data a probability of the region including one or more persons having the target demographic further comprises:
determining from the micro-impulse radar data at least one of a size of a person, a shape of a person, density of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons in the region, accompaniment by at least one child, location of one or more persons in the region; proximity of two or more persons in the region to one another, orientation of one or more persons in the region relative to a media output device, location of one or more persons in the region relative to the media output device, direction of motion, speed of motion, presence of obstructions between one or more persons and the media output device, residence time of a person within the region, or accompaniment by at least one animal.

50. The method for delivering media content to at least one person corresponding to a target demographic of claim 42, wherein the demographic includes at least one of gender, age group, detectable health, hunger, child caregiver, or animal owner.

51. The method for delivering media content to at least one person corresponding to a target demographic of claim 42, wherein outputting human-perceptible media content includes driving a video display including a display screen or a portable video player.

52. The method for delivering media content to at least one person corresponding to a target demographic of claim 42, wherein outputting human-perceptible media content includes driving an audio player including driving a speaker or a portable audio player.

53. The method for delivering media content to at least one person corresponding to a target demographic of claim 42, wherein the target demographic includes a plurality of target demographics; and further comprising:
selecting at least one of a plurality of media contents responsive to determining a probability of a particular target demographic.

54. The method for delivering media content to at least one person corresponding to a target demographic of claim 53, wherein selecting at least one of a plurality of media contents includes selecting at least one media file from a computer storage medium.

55. The method for delivering media content to at least one person corresponding to a target demographic of claim 53, wherein selecting at least one of a plurality of media contents includes selecting at least one of a plurality of media channels cumulatively or selectively received by a network interface.

56. The method for delivering media content to at least one person corresponding to a target demographic of claim 42, further comprising:
selecting media content responsive to a number of persons in the region.

57. The method for delivering media content to at least one person corresponding to a target demographic of claim 42, further comprising:
selecting media content responsive to a plurality of demographics corresponding to persons in the region.

58. The method for delivering media content to at least one person corresponding to a target demographic of claim 42, further comprising:
selecting media content responsive to at least one of a time, a day, a date, a temperature, a humidity, a location, an ambient sound level, or an ambient light level.

59. The method for delivering media content to at least one person corresponding to a target demographic of claim 42, further comprising:
reading a metadata file including target demographic metadata corresponding to available media content; and
selecting media content responsive to a match between the metadata and the determined target demographic.

60. The method for delivering media content to at least one person corresponding to a target demographic of claim 42, wherein available media content is held in a plurality of media files or streams; and further comprising:
comparing metadata embedded in media file headers or packet headers to the determined demographic; and
selecting a media file or media stream responsive to a match between the metadata and the determined target demographic.

61. The method for delivering media content to at least one person corresponding to a target demographic of claim 42, further comprising:
subscribing to a multicast media channel to receive media content corresponding to a least one demographic met by the at least one person.

62. The method for delivering media content to at least one person corresponding to a target demographic of claim 42, further comprising:
determining from the micro-impulse radar data a location or orientation of one or more persons in the region; and
wherein media content selection includes selecting media content responsive to the orientation or location of the one or more persons.

63. The method for delivering media content to at least one person corresponding to a target demographic of claim 42, further comprising:
determining from the micro-impulse radar data a location or orientation of one or more persons relative to at least one perceptible media content output device.

64. The method for delivering media content to at least one person corresponding to a target demographic of claim 63, further comprising:
selecting at least one media content output device for outputting the media content responsive to the orientation or location of at least one person relative to the media content output device.

65. The method for delivering media content to at least one person corresponding to a target demographic of claim 63, further comprising:
controlling an output device attribute responsive to at least one of orientation or location.

66. The method for delivering media content to at least one person corresponding to a target demographic of claim 65, wherein controlling an output device attribute includes controlling at least one of video resolution, video magnification, video color, video brightness, video sharpness, audio volume, audio channel separation, or audio compression.

67. The method for delivering media content to at least one person corresponding to a target demographic of claim 42, wherein outputting human-perceptible media content includes outputting signage, outputting a signal, outputting audio, outputting video, or outputting audio/video content.

68. The method for delivering media content to at least one person corresponding to a target demographic of claim 42, further comprising:
recording detected demographics and output media content.

69. The method for delivering media content to at least one person corresponding to a target demographic of claim 42, wherein the target demographic includes at least one of a grouping of persons having a similar trait, a grouping of persons not having a similar trait, a plurality of groupings of persons having similar respective traits, a plurality of groupings of persons not having the similar respective traits, or one or more groupings of persons having similar traits and not having other similar traits.

70. The method for delivering media content to at least one person corresponding to a target demographic of claim 42, further comprising:
determining from the micro-impulse radar data a second probability of the region including one or more persons corresponding to a prohibited demographic; and
prohibiting output of prohibited media content responsive to value of the second probability.

71. The method for delivering media content to at least one person corresponding to a target demographic of claim 42, further comprising:
selecting the one or more media files or streams from the plurality of media files or streams.

72. The method for delivering media content to at least one person corresponding to a target demographic of claim 71, wherein selecting one or more media files or streams includes selecting according to one or more of a demographic score, a randomizer, a circular buffer, a contractual obligation, or an output interval.

73. A method for providing selected information to one or more persons, comprising:
receiving from a micro-impulse radar, information corresponding to one or more characteristics of one or more persons in a region; and
outputting media to the region responsive to the one or more characteristics.

74. The method for providing selected information to one or more persons of claim 73, wherein outputting media includes outputting human perceptible media.

75. The method for providing selected information to one or more persons of claim 73, wherein information corresponding to one or more characteristics includes information corresponding to one or more of a size of a person, a shape of a person, density of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons in the region, accompaniment by at least one child, location of one or more persons in the region; proximity of two or more persons in the region to one another, orientation of one or more persons in the region relative to a media output device, location of one or more persons in the region relative to the media output device, direction of motion, speed of motion, presence of obstructions between one or more persons and the media output device, residence time of a person within the region, or accompaniment by at least one animal.

76. The method for providing selected information to one or more persons of claim 73, further comprising:
selecting for output one or more sets of media content corresponding to the one or more characteristics.

77. The method for providing selected information to one or more persons of claim 73, wherein the micro-impulse radar is configured to provide an image of the region.

78. The method for providing selected information to one or more persons of claim 77, wherein the micro-impulse radar is configured to provide a series of images of the region.

79. The method for providing selected information to one or more persons of claim 73, wherein the micro-impulse radar is configured to capture and analyze an image or series of images of the region and provide an image analysis result.

80. The method for providing selected information to one or more persons of claim 73, wherein outputting media includes outputting signage, outputting a signal, outputting audio, outputting video, or outputting audio/video content.

81. The method for providing selected information to one or more persons of claim 73, wherein the information corresponding to one or more characteristics of one or more persons in a region includes one or more of spatial information, time-domain motion information, and frequency domain information.

82. A media output system configured to output content responsive to at least one human demographic, comprising:
a media output device configured to output media content to a receiving region;
a micro-impulse radar configured to probe an examination region and generate an output signal; and
a controller configured to receive the output signal, determine one or more human demographics entering or in the receiving region, and responsively select media content for output through the media output device.

83. The media output system configured to output content responsive to at least one human demographic of claim 82, wherein the media output device includes at least one of a selectable sign, an audio output, a video display, or an audio/video display.

84. The media output system configured to output content responsive to at least one human demographic of claim 82, wherein the viewing region and the probed second region are substantially overlapping.

85. The media output system configured to output content responsive to at least one human demographic of claim 82, wherein the micro-impulse radar is configured to detect and include in the output signal information corresponding to one or more of a size of a person, a shape of a person, density of a person, detectable ornamentation associated with a person, detectable clothing worn by a person, a heart rate, a heart arrhythmia, a heart size, a respiration rate, a respiration irregularity, a diaphragm motion, a diaphragm spasm, body movements, posture, a head-to-body size ratio, a detectable health, an in utero fetus, a prosthesis, a personal appliance, a number of persons in the region, accompaniment by at least one child, location of one or more persons in the region; proximity of two or more persons in the region to one another, orientation of one or more persons in the region relative to a media output device, location of one or more persons in the region relative to the media output device, direction of motion, speed of motion, presence of obstructions between one or more persons and the media output device, residence time of a person within the region, or accompaniment by at least one animal; and
wherein the controller is configured to determine the one or more human demographics from the information detected by and included in the output signal of the micro-impulse radar.

86. The media output system configured to output content responsive to at least one human demographic of claim 82, wherein the controller is configured to select media content for output by subscribing to a media multicast or reading one or more stored media files targeted at the one or more human demographics.

87. The media output system configured to output content responsive to at least one human demographic of claim 82, further comprising a kiosk or housing configured to provide media display in a public space responsive to the human demographics of one or more persons entering or in the receiving region.

88. The media output system configured to output content responsive to at least one human demographic of claim 82, wherein the examination region and the receiving region are adjacent and abutting one another.

89. The media output system configured to output content responsive to at least one human demographic of claim 82, wherein the examination region and the receiving region are separated, and wherein the controller includes a content output queue corresponding to respective demographics of persons moving from the examination region to the receiving region.

90. A control module for an adaptive media delivery system, comprising:
a media source;
a display drive port configured to drive one or more media displays;
a media delivery controller operatively coupled to the media source and the display drive port; and
a micro-impulse radar or a micro-impulse radar port configured to provide data related to at least one viewer or potential viewer to the media delivery controller.

91. The control module for an adaptive media delivery system of claim 90, wherein the media source includes a media download port configured to receive media files or media streams from a network.

92. The control module for an adaptive media delivery system of claim 90, wherein the media source includes at least one computer-readable storage medium configured to store media files.

93. The control module for an adaptive media delivery system of claim 90, wherein the media source includes an interface to a separate media storage medium.

94. The control module for an adaptive media delivery system of claim 90, wherein the media delivery controller is configured to select media for output through the display drive port responsive to the data related to at least one viewer or potential viewer.

95. The control module for an adaptive media delivery system of claim 90, wherein the micro-impulse radar or micro-impulse radar port is configured to provide reflected pulse waveforms to the media delivery controller.

96. The control module for an adaptive media delivery system of claim 90, wherein the micro-impulse radar or micro-impulse radar port is configured to provide processed data to the media delivery controller.

97. The control module for an adaptive media delivery system of claim 90, wherein the micro-impulse radar or micro-impulse radar port consists essentially of an embedded micro-impulse radar.

98. A tangible computer readable medium carrying computer-executable instructions configured to cause a computer to:
receive micro-impulse radar data;
determine at least one human demographic from the micro-impulse radar data; and
select for output media content as a function of the human demographic.

99. The tangible computer readable medium carrying computer-executable instructions of claim 98, wherein the instructions are further configured to cause the computer to:
prohibit output of media content not suitable for at least one determined human demographic.

100. The tangible computer readable medium carrying computer-executable instructions of claim 98, wherein the instructions are further configured to cause the computer to:
drive a media output device to output the selected media content.

101. The tangible computer readable medium carrying computer-executable instructions of claim 100, wherein the instructions are configured to cause the computer to drive at least one of a video display, an audio output, a selectable sign, or an audio/video display.

102. The tangible computer readable medium carrying computer-executable instructions of claim 98, wherein selecting media content for output includes making an operative coupling to a media download port configured to receive media files or media streams from a network.

103. The tangible computer readable medium carrying computer-executable instructions of claim 98, wherein selecting media content for output includes reading one or more media files from at least one computer-readable storage medium.

104. The tangible computer readable medium carrying computer-executable instructions of claim 98, wherein receiving micro-impulse radar data includes receiving reflected pulse waveforms and performing signal processing on the received reflected pulse waveforms.

105. The tangible computer readable medium carrying computer-executable instructions of claim 98, wherein receiving micro-impulse radar data includes receiving processed data from a micro-impulse radar signal processor.
